(19) United States
(12) Patent Application Publication
(10) Pub. No.: US 2010/0070379 A1
(43) Pub. Date: Mar. 18, 2010

(54) METHOD FOR SELLING OF PRODUCTS

(75) Inventor: Dennis NEPOMNIASHY, Tallinn (EE)

Correspondence Address: YOUNG & THOMPSON, 209 Madison Street, Suite 500, Alexandria, VA, 22314, US

(73) Assignee: THINK SMART OU, Tallinn (EE)

(21) Appl. No.: 12/480,139

(22) Filed: Jun. 8, 2009

(30) Foreign Application Priority Data
Sep. 15, 2008 (EE) U200800098

(51) Int. Cl. G06Q 30/00; G06Q 10/00

(52) U.S. Cl. 705/26; 705/400

(57) ABSTRACT

The purpose of the present invention is to offer a solution to provide a method for a user of a communication network to purchase a product using a simple and safe method based on a mobile or fixed phone communication or a computer network. The method of the invention is implemented by a system, consisted of the following devices, configured to communicate mutually, using a mobile, wireless or fixed communication network: a central server, comprising a database with different information on the products on sale. The central server will be communicated by a phone operator or a bank payment system, and a potential buyer and the seller, which also use mobile, wireless or fixed communication network to be connected to the system.

### FIELD OF THE INVENTION

The present invention represents a method, offering a medium for selling of different products.

### BACKGROUND OF THE INVENTION

EP1785918 discloses a system for arranging a Dutch auction, consisting of a monitor section for displaying the auction price. The section of downcounting programme is outlined to set the initial price and to lower the price. The stop-indication section is outlined to detect the stopping command for the participants and to stop the downcounting. The central computer or central server comprises the software. The server belongs to the auctioneer and is connected with several local computers by means of communication channels. The computers are used by the participants.

JP2002015171 discloses a method of auction, which is most suitable for usage over mobile network. A participant selects the desired object and the server offers the object for a Dutch auction, with the price lowered by certain time intervals, until the price suits the participant and he or she transfers the respective amount of money. If there are many participants, whose total umber exceeds the number of the objects, a new “upbidding” auction can be arranged.

GB2363483 discloses a method for an auction, performed over a computer network, e.g. the Internet. The central processor saves the parameters of the auction, e.g. the current price, the description and the specification of the product. The parameters are received by the participant computers in order to make their bidding action possible. The bids are received by the central processor, and combined with the existing parameters. Likewise, the central processor periodically updates the parameters, lowering the current price. The auction will be stopped at the moment when the highest bid meets the current price. The participants can make also “reservation” bids. The participants are informed about the start and the end of the auction. This system is also realizable using WAP-technology.

CA2394575 discloses an auction system, consisting of a server system for distributing the current prices and receiving the bids; therewith the information is distributed by single IP-packets (more specifically called User Data Protocol). This technology reduces significantly the latency of data transformation. The system described is suitable for arranging of a Dutch auction. The system has also an interface including a clock appliance to display the current price, which is calculated from the received messages, and also other type of information.

The present level solutions do not offer any possibility for a participant to lower the price by successive calls until the price will be acceptable.

### SUMMARY OF THE INVENTION

The object of the invention is to offer a solution, which enables a simple and safe way to purchase a product using mobile or fixed telephone communication, or computer network.

The method of the invention is implemented by a system of the following devices, configured to communicate with each other via mobile, fixed or wireless connections:
a central server with different product information fed by the system and connected with:
phone operator or bank
buyer and seller, connected to the system via mobile or fixed communications

The operation of the invention consists of the following stages:
the seller calls the central server and forwards the offer to sale a product plus main information about the product, inter alia the initial price X and the time period of the bidding;
after a certain time interval, a potential buyer gets in touch with the central server, and as the result, a certain amount of money is transferred to the server by a mobile phone operator or by the bank, using fixed communications;
the price is lowered by means of the server to enable the purchase of the product by the buyer;
if the potential buyer has made a negative decision, the communication between the participant and the server will be interrupted, and the system is transferred to pending mode, until the next potential buyer calls; the price is lowered again to enable the potential buyer to purchase the product;
the communication sessions between the server and potential buyers are proceeded, until a buyer is found, who accepts the current price, or the bidding is terminated by the time foreseen

### BRIEF DESCRIPTION OF THE DRAWINGS

Presenting the description of the preferred version of the invention, references to attached figures are made, with:

FIG. 1 presenting the block diagram of the system for implementing the appropriate method of the invention,

FIG. 2 presenting the diagram of the appropriate method of the invention, showing the change of the product price, following the calls of potential buyers.

FIG. 3 presenting another version for diagram of the appropriate method of the invention, representing the full cycle of the product in time scale, i.e. from the moment of disposal to the act of purchase.

### DETAILED DISCLOSURE OF THE INVENTION

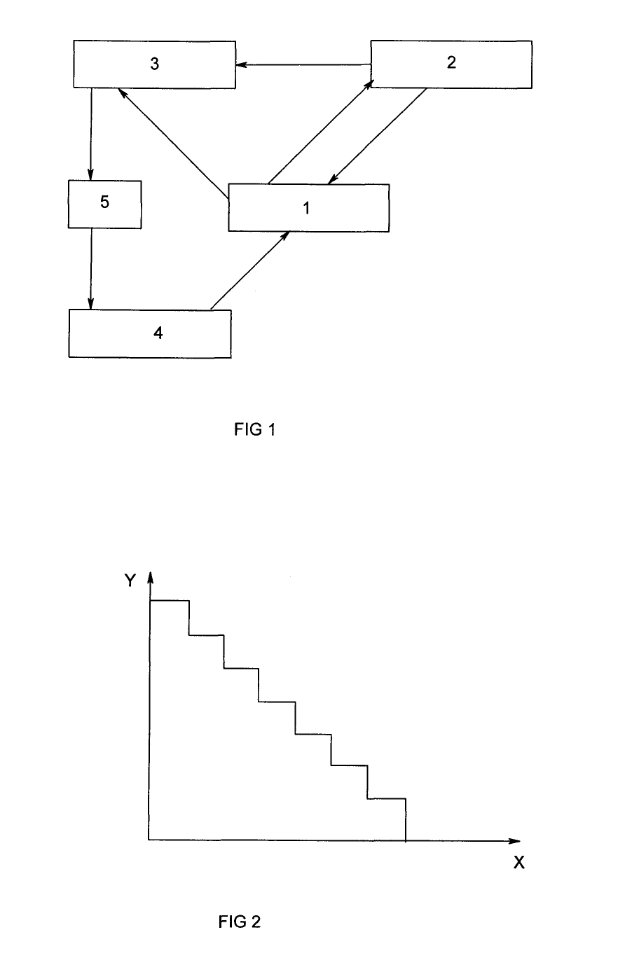

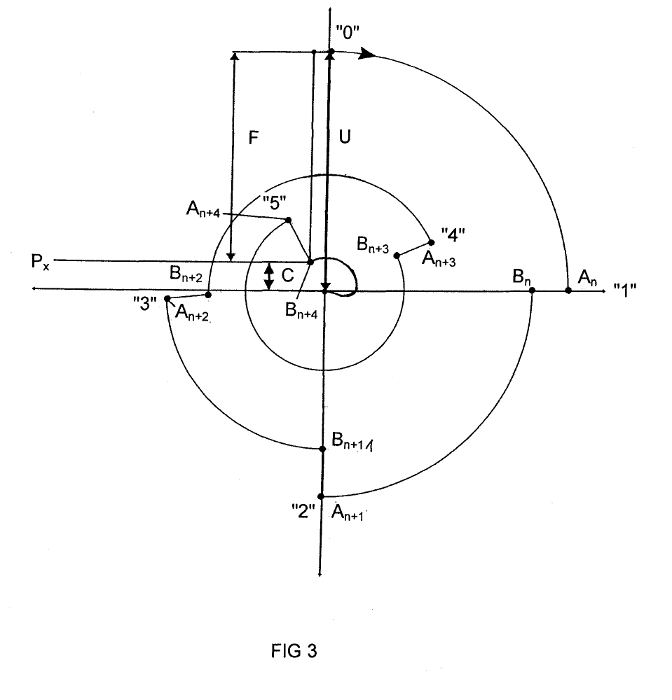

The system of the realization of the appropriate method of the invention, according to FIG. 1, is comprised of the central server 1, to which a seller 2 and a buyer 3 are connected via a wireless or wired communication network. The seller and the buyer are also mutually connected via a connection line. In addition, a phone operator or a bank 4 is connected to the system, which will receive the actual price 5 for the product. The central server administers the whole system, receives the bids of potential buyers, displays the product information and the time left to the end of the bidding period. FIG. 2 displays a diagram of the method, presenting the change of the product price resulting from the calls of potential buyers, while the number of buyers is on the x-axis and the product price, descending with each call, is on the y-axis. In the initial state “0”, the product price is Aₙ. With the first buyer calling, (moment “1”) the central server lowers the price by one step, e.g. 10 EEK, so that the new price will be Bₙ (Aₙ−Bₙ=10). Similarly, the next call (moment “2”) will involve the next decrease of the price by the same amount (10 EEK) (Aₙ₊₁−Bₙ₊₁=10). This process will continue to the moment when one potential buyer decides to purchase the product, e.g. at the moment “5”, when the product price is (Aₙ₊₄−Bₙ₊₄=C). The exit point of the product is marked by the symbol Pₓ. while the price may have reached whatever level, included zero. The method comprises the following stages:
an agreement is made between the seller 2 and the central server 1 (stage I),
in the initial state “0” (see FIG. 3), information about the product(s) is made available via the central server 1 for the users of the system (buyers) (stage II),
at the point “1”, buyer 3 opens the communication line by calling, sending a SMS message or through the bank, with the result that the new price of the product Bₙ (i.e. the initial price at the moment “0” minus the fee for using the communication line, e.g. 10 EEK) will be displayed for the buyer 3 in the central server 1,
If the price Bₙ suits buyer 3, the central server 1 will make available an agreed period for the buyer 3 to purchase the product: the central server 1 transfers the corresponding identification code to the buyer, whereupon the payment is made by the buyer, using an agreed mode of payment, e.g. COD (Cash on Delivery), CCard, cash in hand.
If the buyer does not take advantage of his or her opportunity within the predetermined period of time, the communication line is made available for all interested persons again,
when the next potential buyer opens a communication line to the server, the product price will be lowered by successive 10 EEK,
similar cycles will be repeated, until the evolved price will suit a buyer, and the product will be sold; otherwise the process will continue and the product price will be lowered—even until zero, if no real purchaser will be found.

In this case, the seller will principally receive an amount of money for the product, because the potential buyers have transferred an amount of money to the central server, i.e. 10 EEK for each call, which will be transferred to the seller, after subtraction of the administration fee,

The central server may offer an additional service of notifying a buyer of certain reductions of the price, e.g. by 100/200/300 EEK.

The appropriate method of the invention may be illustrated by the following example: suppose the initial price of a TV set is 10,000 EEK. After 100 calls the price will be 9,000 EEK, after 853 calls (F=8530 EEK) the price has descended to C=1470 EEK. A user of the central server will agree to this price and the purchase will be confirmed, i.e. the user will get an identification code. When the buyer has paid 1470 EEK, the collected amount of money minus administration fee (e.g. 10 per cent of the initial price) is transferred to the seller, i.e. 8350−1000=7350 EEK.

1. A method for sale using a system of interconnected devices, consisting of central server (1), seller (2) and buyer (3), phone operator or bank (4), characterized in that comprised of the following stages:
an agreement is made between the seller (2) of the product and the central server (1) (stage I),
at the initial point “0” (see FIG. 2), information about the products offered is made available to the users of the central server (1) (potential buyers) (stage II),
at the moment “1”, a buyer (3) opens a connection line, either by calling, sending a SMS message or through the bank, and the current price Bₙ of the product is displayed by the central server (1) for the buyer (3), i.e. the initial price minus the fee for opening the connection line (e.g. 10 EEK),
if the price Bₙ suits the buyer (3), the central server will provide a predetermined time period by the central server (1) to implement the purchase and an identification code will be given to the buyer; the payment is made using the agreed method of payment,
if, within the predetermined time period, the buyer (3) fails to use the right to purchase the product, the connection line will be opened for all interested persons again,
while the next buyer opens the connection line with the server, the server will lower the product price by further 10 EEK,
the similar stages will be repeated, until the current price will suit a buyer, and the purchase will be executed; otherwise, the price continues to decrease, approaching zero level.

2. A method to sell products, according to claim 1, characterized in that the time period for the process is fixed.

3. A method to sell products, according to claim 1, characterized in that the time period for the process is not fixed.

4. A method to sell products, according to claim 1, characterized in that the time period, predetermined by the central server (1) for purchasing the product, is 7 seconds.

5. A method to sell products, according to claim 1, characterized in that the payment for the product is made using the following modes of payment: COD (Cash on Delivery), CCard, cash in hand.

6. A method to sell products, according to claim 1, characterized in that the central server (1) is connected by phone call, SMS message or bank transaction.

7. A method to sell products, according to claim 1, characterized in that the purchaser of the product will be provided an opportunity to reoffer the product for sale through the database of the central server (1).
